(19) United States
(12) Patent Application Publication
(10) Pub. No.: US 2018/0101506 A1
(43) Pub. Date: Apr. 12, 2018

(54) User Interface

(71) Applicant: Microsoft Technology Licensing, LLC, Redmond, WA (US)

(72) Inventors: Darius A. Hodaei, London (GB); Gregor Mark Edwards, London (GB); Baljinder Pal Rayit, Redmond, WA (US)

(73) Assignee: Microsoft Technology Licensing, LLC, Redmond, WA (US)

(21) Appl. No.: 15/406,055

(22) Filed: Jan. 13, 2017

(30) Foreign Application Priority Data
Oct. 6, 2016 (GB) 1616990.6

(51) Int. Cl. G06F 17/22; G06F 17/21; G06F 9/44

(52) U.S. Cl. CPC G06F 17/2247; G06F 9/4443; G06F 17/218

(57) ABSTRACT

A computer system for use in rendering a user interface comprises: an input configured to receive a series of natural language user interface description elements describing intended user interface attributes; electronic storage configured to hold model data for interpreting the natural language description elements; an interpretation module configured to apply natural language interpretation to the natural language description elements to interpret them according to the model data, thereby identifying the intended user interface attributes; a generation module configured to use results of the natural language interpretation to generate a data structure for rendering a user interface exhibiting the identified attributes; and a rendering module configured to use the data structure to cause a display to render on the display a user interface exhibiting the intended attributes.

### RELATED APPLICATIONS

This application claims priority under 35 U.S.C. 119 or 365 to Great Britain Application No. 1616990.6 filed Oct. 6, 2016, the disclosure of which is hereby incorporated by reference in its entirety.

### TECHNICAL FIELD

The present invention relates to a computer system for use in rendering a user interface on a display.

### BACKGROUND

A user interface (UI) refers to a mechanism by which a user and a computer can interact with one another. A user interface may be rendered in a number of ways. For example, an application executed on a processor of a user device may include user interface instructions which, when executed on the processor, cause a display of the user device to render a user interface defined by the instructions. As another example, a user interface may be rendered by an application, such as a web browser, which is executed on a processor of a user device. The application may render the user interface according to user interface code (e.g. HTML) defining the user interface. In this case, the user interface code is interpreted by the application in order to render a user interface defined by the user interface code.

A user interface can comprise components, at least some of which may be selectable using an input device of the user device, such as a touchscreen, mouse, or track pad. For example, a user may be able to select components to navigate through the user interface dynamically, providing a two-way interaction between the user and the computer.

### SUMMARY

A first aspect of the present invention is directed to a computer system for use in rendering a user interface. The computer system comprises the following:

an input configured to receive a series of natural language user interface description elements describing intended user interface attributes;

electronic storage configured to hold model data for interpreting the natural language description elements;

an interpretation module configured to apply natural language interpretation to the natural language description elements to interpret them according to the model data, thereby identifying the intended user interface attributes;

a generation module configured to use results of the natural language interpretation to generate a data structure for rendering a user interface exhibiting the identified attributes; and

a rendering module configured to use the data structure to cause a display to render on the display a user interface exhibiting the intended attributes.

The present invention allows a UI developer or team of developers to design a user interface using natural language. This allows, for example, different developers with different skills and technical knowledge to collaborate on a user interface design in an engaging manner, without those differences becoming a barrier to collaboration.

In embodiments, the computer system may be configured to generate context data as the series of natural language description elements is received and interpreted, and use the context data to resolve a vague identifier in at least one of the natural language description elements, the vague identifier being resolved to a user interface component of the data structure identified by the context data.

The context data may identify a most recently interacted with user interface component of the data structure, to which the vague identifier is resolved.

The natural language interpretation may comprise interpreting at least one of the natural language description elements by identifying an intended modification expressed by it in natural language, and the generation module may be configured to apply the intended modification to the data structure.

The intended modification may be expressed by the natural language description element containing the vague identifier and is applied to the user interface component identified by the context data.

The interpretation module may be configured to identify a component name in the description element expressing the intended modification, and the intended modification may be applied to a user interface component of the data structure having that name.

The modification may be applied by creating a new user interface component in the data structure.

The modification may be applied by modifying the data structure to associate a user interface component of the data structure with at least one other user interface component of the data structure. The rendering module may be configured to cause those user interface components to be rendered on the display based on the association between them in the data structure.

The data structure may be modified to mark the other user interface component as a child to the user interface component.

The rendering module may be configured to use the modified data structure to cause a modified version of the user interface to be rendered on the display. For example, the rendering module may be configured to cause any of the new and/or modified user interface components of the data structure to be rendered on the display, as part of the rendered user interface.

The intended modification may be applied by generating functional data and/or display data within the data structure in association with at least one user interface component of the data structure, wherein the rendering module may be configured to use the functional and/or display data in causing the user interface component to be rendered on the display.

The display data may define a colour and/or a layout and/or an animation effect for the associated user interface component, which is rendered on the display.

The functional data may define an action to be performed, wherein the rendering module is configured to use the functional data to render the associated user interface as a selectable component such that the defined action is performed when that component is selected. For example, the functional data may comprise a link (e.g. URI, URL, etc.) to an addressable memory location, to be accessed when the user interface components are rendered and displayed.

The natural language description elements may be received as part of a real-time conversation between at least one user and a bot (i.e. an autonomous software agent implemented by the computer system) comprising the generation module.

The data structure may have a markup language format (e.g. extensible markup language (XML), hypertext markup language (HTML), etc.), a JavaScript object notation (JSON) format, or a React format.

The computer system may comprise a format conversion module configured to generate a corresponding data structure having a different format. For example, to convert from XML into HTML, JSON, React, etc.

The data structure may be an in-memory data structure, and the computer system may comprise a serialisation module configured to generate a serialized version of the data structure.

The serialized version of the data structure may have a markup language format (e.g. XML, HTML), a JSON format, or a React format.

A second aspect of the present invention is directed to a computer-implemented method of causing a user interface to be rendered on a display, the method comprising implementing, by a computer system, the following steps:

receiving a series of natural language user interface description elements describing intended user interface attributes;

causing natural language interpretation to be applied to the natural language description elements to interpret them according to electronically stored model data, thereby identifying the intended user interface attributes;

using results of the natural language interpretation to generate a data structure for rendering a user interface exhibiting the identified attributes; and

using the data structure to cause a display to render on the display a user interface exhibiting the intended attributes.

In embodiments, the steps further comprise: generating context data as the series of natural language description elements is received and interpreted; and using the context data to resolve a vague identifier in at least one of the natural language description elements, the vague identifier being resolved to a user interface component of the data structure identified by the context data.

The context data may identify a most recently interacted with user interface component of the data structure, to which the vague identifier is resolved.

The natural language interpretation may comprise interpreting at least one of the natural language description elements by identifying an intended modification expressed by it in natural language, and the steps may comprise applying the intended modification to the data structure.

In embodiments of the second aspect, any of the functionality described in relation to embodiments of the first aspects may be implemented.

A third aspect of the present invention is directed to a computer program product comprising code stored on a computer readable storage medium and configured when executed to implement any of the methods or system functionality disclosed herein.

### BRIEF DESCRIPTION OF FIGURES

For a better understanding of the present invention, and to show how embodiments of the same may be carried into effect, reference is made by way of example only to the following figures, in which:

FIG. 1 shows a schematic block diagram of a communication system;

FIG. 2 shows a functional block diagram representing functionality implemented by a computer system for generating a user interface data structure;

FIG. 3 shows an example result generated by a natural language interpretation module;

FIGS. 4a and 4b illustrate how an exemplary user interface data structure may be generated using natural language;

FIG. 5 shows a functional block diagram representing functionality implemented by a computer system for processing and rendering a user interface data structure;

FIG. 6 shows an example of a generated user interface data structure embodied in XML;

FIG. 7 shows an example communication interface for use in generating a user interface data structure using natural language; and

FIG. 8 shows an example architecture of a back-end system.

### DETAILED DESCRIPTION OF EXAMPLE EMBODIMENTS

The described technology allows a UI developer or team of collaborating UI developers to describe the composition of a user interface using natural language (NL), in order to automatically generate a user interface design.

The user interface design is an electronically stored data structure, which formally defines intended attributes of a user interface to be rendered on a display—those attributes having been expressed informally by the team using free-form natural language (such that the same underlying intent can be expressed in different ways using different choices of natural language), and identified by applying computer-implemented natural language interpretation using a suitably-trained machine learning (ML) model. This formal user interface description is susceptible to efficient and predictable interpretation by a conventional (non-ML) computer program, in order to render a user interface exhibiting the intended attributes. The user interface design is used in order to automatically render a user interface exhibiting those attributes on a display. This can for example be a display available to one of the UI developers, so that they can preview and test the user interface as they design it. As another example, this could be a display available to an end user, where the user interface is rendered in an operational (i.e. “live” context) once the design has been completed. The user interface may be interactive, in the sense described above.

A user interface can be composed of components (e.g. button, avatar, text title, etc.). That is, the user interface data structure is formed of user interface components, which are created in response to natural language commands, and which define corresponding visible components of the user interface to be rendered on the display. In this context, attributes can refer to the components, any display data, and/or functional data associated with the components in the data structure, and any associations between the components within the data structure.

The user interface design is generated by a bot, which parses the natural language and continuously amends the generated design on the fly in real-time (DescribeUI bot). A bot is an autonomous software agent which is able to action intents expressed by one or more users in natural language. The intent can be derived from a conversation in which the user(s) is engaged with the autonomous software agent and one or more users at a remote user device. Alternatively, the intent can be conveyed in a message directly from the user to the agent, for example in a video or audio call or text message. That is, in a one-to-one communication between the user and the bot. Where the intent is derived from a conversation, the term “listening” is used in relation to the bot's processing of the natural language.

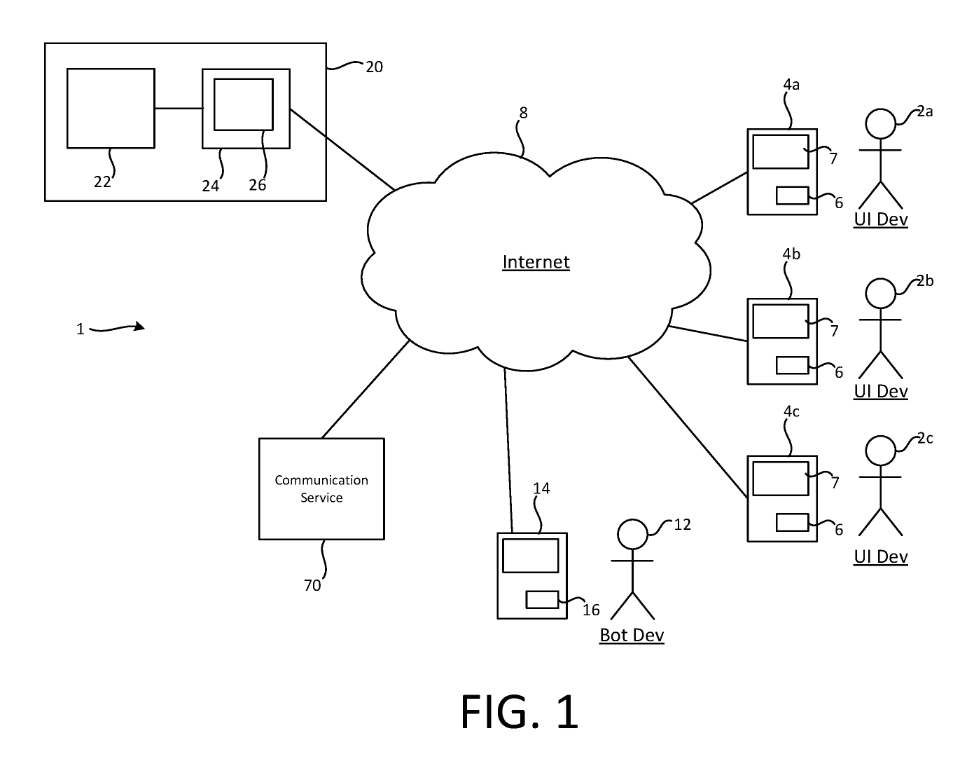

FIG. 1 shows a schematic block diagram of a communication system 1, which comprises a network 8. Shown connected to the network 8 are: one or more first user devices 4a, 4b, and 4c operated by one or more first users 2a, 2b, and 2c (UI development team), a second user device 14 operated by a second user 12 (bot developer), and a computer system 20 (the back-end). A communications service 70 is also shown, which represents functionality within the communication system that allows the users 2 to communicate with one another and the bot.

The network 8 is a packet-based computer network, such as the Internet.

The computer system 20 comprises at least one processor 22 communicatively coupled to electronic storage 24. The electronic storage 24 holds software (i.e. executable instructions) 26 for execution on the processor 22, referred to as back-end software below. Among other things, the processor 22 is configured to execute the back-end software 26 and thereby implement the DescribeUI bot, whose functionality is described in detail below.

Each of the first user devices 4 comprises a display 7 and a processor 6, such as a CPU or CPUs, on which a client application is executed. When executed, the client application allows the users 2 to access the communications service 70 via their user devices 4. This allows the UI developers 2 to communicate with each other, and with the computer system 20, in a real-time communication event (conversation), such as an audio call, video call (e.g. voice/video over internet provider (VoIP) based call) or (text-based) instant messaging (IM) session, conducted via the network 8.

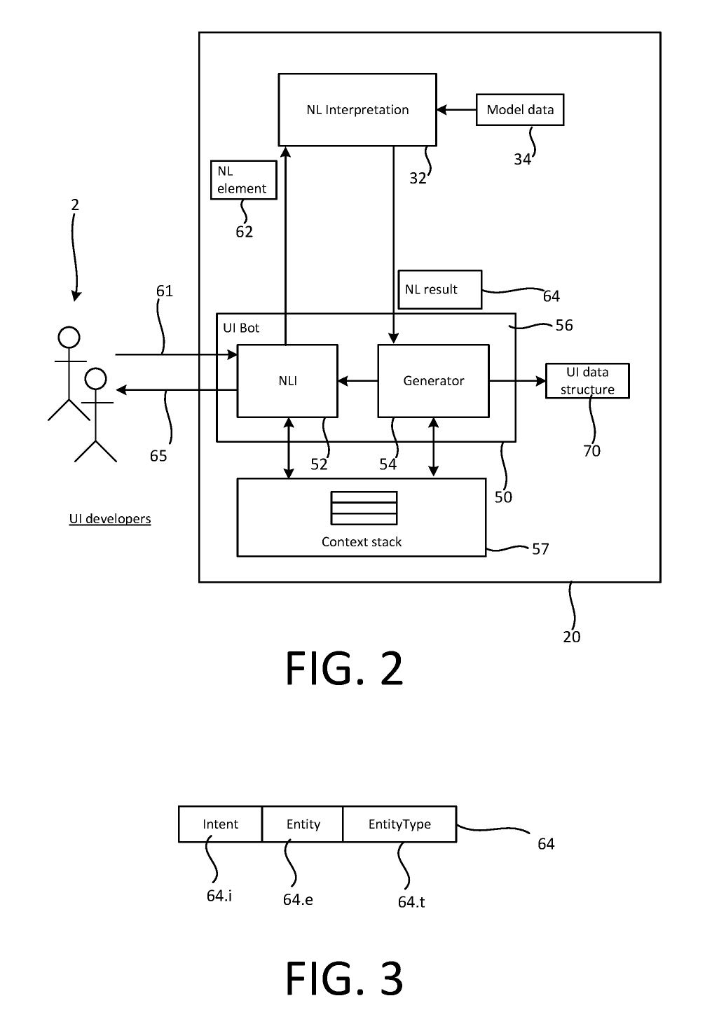

User(s) 2 can use natural language (as text or speech) in order to describe the facets and characteristics of a user interface design during the conversation. The DescribeUI bot is also present as a participant in the communication event and parses the phrases, interprets them against a machine learning model (model data 34, FIG. 2), and iteratively amends the designed artifact over the course of the conversation in real time.

For example, the user or users 2 can join a conversation group on an IM/VoIP client. The conversation also has the DescribeUI bot present, listening to what is being discussed by the human members 2.

This means that all contributors have a common way of expressing their intent and wants without their differing skill sets creating barriers to collaboration.

Accordingly, it is possible for many users to collaborate on the design of a user interface. This is particularly beneficial where the contributors are situated across several sites, or if they do not normally use the same set of tools/software across a team, or where they have different expertise (e.g. engineer versus designer) across a team.

The bot developer's device 14 comprises a processor 16 which executes an application, such as a web browser, to allow him to configure operating parameters of the DescribeUI bot, as described later.

FIG. 2 shows a functional block diagram representing functionality implemented by the computer system 20. As shown, the computer system 20 comprises a natural language interface (NLI) 52, a UI design generation module 54 and a NL interpretation module 32. These modules 32, 52, and 54 are functional modules, each representing functionality implemented by a respective portion of the back-end software 26 when executed. The DescribeUI Bot is labelled 56 in FIG. 2, and is shown to comprise the NLI 52 and the UI design generation module 54. That is, the NLI 52 and UI design generation module 54 represent functionality of the DescribeUI Bot.

The NLI 52 is configured to receive natural language inputs 61 from users 2. These are received via the network 8 as part of a communication event in which the bot 56 is a participant, though this is not shown in FIG. 2. These can be received as text or audio data. The NLI 52 interacts with the NL interpretation module, by outputting natural language description elements 62 derived from the natural language inputs 61 to the NL interpretation module 32. These can for example be text extracted directly from text inputs, or from audio data using speech-to-text conversion.

The NL interpretation module 32 applies natural language interpretation to each NL description element 62. When successful, this generates a result 64, which is returned to bot 56, as described in more detail later.

The UI design generation module 54 of the DescribeUI bot 56 receives the results 64. Based on the received results 64, the UI design generator module 54 generates and updates the user interface design 70, which as indicated above is an electronically stored data structure formed of user interface components and generated in electronic storage 24. In particular, the generator module 54 can add new UI components to or modify existing UI components of the data structure 70 based on the results 64 returned by the natural language interpretation module 32.

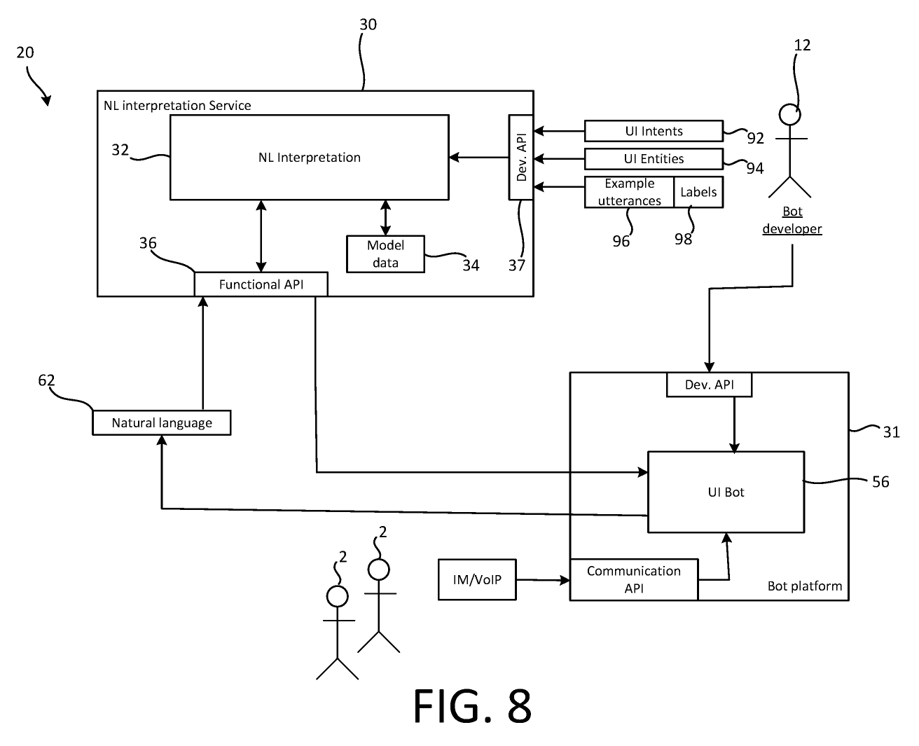

Each of the results 64 is generated by applying natural language interpretation to the NL description element 62 in question, to interpret it according to model data 34 held in the electronic storage 24. The model data 34 is adapted to allow accurate interpretation of natural language words and phrases that are expected from users 2 when collaborating on a user interface design, accounting for the fact that they may have different backgrounds and different levels of expertise. For example, the NL interpretation module may implement a machine learning algorithm, and the model data 34 may be generated by training the algorithm based on anticipated phrases pertaining to UI design and which may be expected from software developers and designers having different backgrounds and levels of technical expertise. This is described in more detail below, with reference to FIG. 8.

In this example, the primary function of the natural language interpretation is intent recognition. That is, to identify, where possible, at least one intent expressed in element 26 using natural language, out of a set of possible intents (92, FIG. 8) previously determined by the bot developer 12. That is, an intended action relating to the design of the user interface, such as adding a new UI component to or modifying an existing UI component of the UI data structure 70.

The NL interpretation may also identify at least one portion of the natural language description element 62 as an “entity”. That is, as a thing to which the identified intent relates. For example, in the phrase “create a component called contact details”, the intent may be recognized as the creation of a new component and the entity as “contact details”. Where an entity is identified, preferably a type of the entity is also recognized, for example a component name type in this example. That is, an entity type from a set of entity types (94, FIG. 8) previously determined by the bot developer 12.

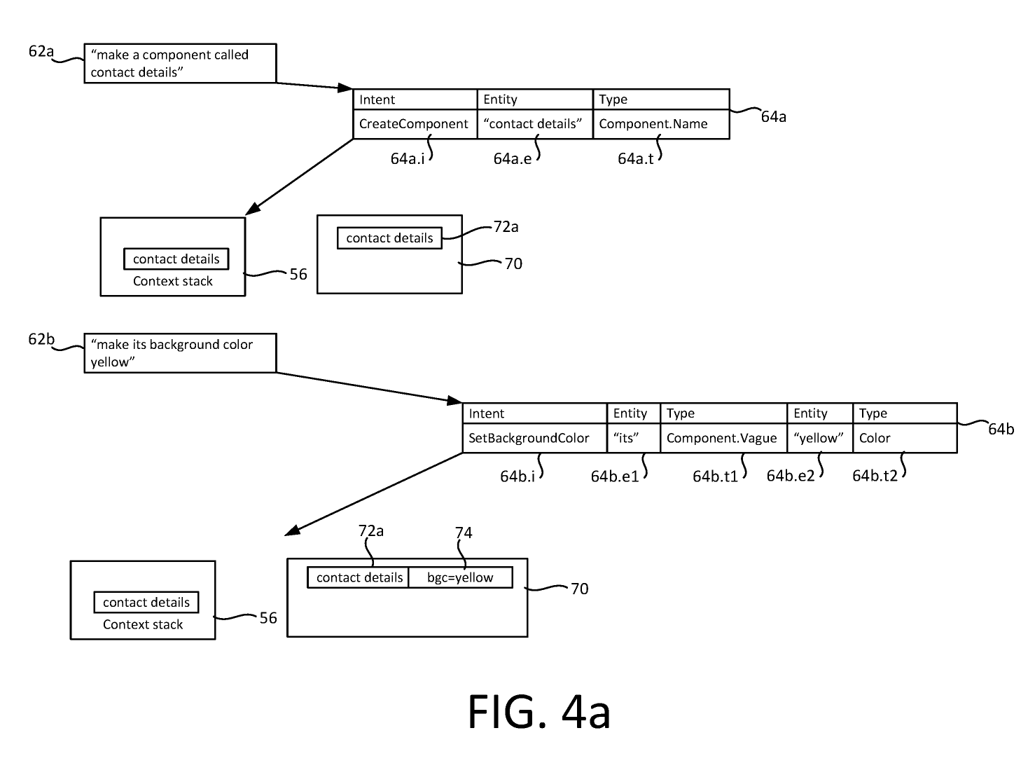

Accordingly, with reference to FIG. 3, a result 64 of the natural language interpretation when successfully applied to a natural language description element 62 comprises at least one intent identifier 64.i, identifying one of the pre-determined set of intents 92. Where applicable, it may also identify at least one entity 64.e occurring within the natural language description element 62. This can for example be an extract of text from the natural language description element 62 (which may or may not be reformatted), or the result 64 may include the original text of the description element 62 marked to show one or more entities occurring within it. Preferably, it also comprises, for each identified entity, a type identifier 64.t for that entity, identifying at least one of the set of predetermined entity types 94 for that entity. The result 64 is thus a formal description of the identified intent(s), as well as any identified entity or entities, and its entity type(s), having a predetermined format susceptible to efficient computer processing.

An output of the generator module 54 is shown as connected to an input of the NLI 52, to illustrate how the NLI 52 may communicate to user(s) 2 information 65 pertaining to the operations of the UI design generation module 54, for example to notify them of successful updates to the UI design 70 and of any problems that have been encountered during the communication event in which the UI is designed.

The bot 56 also maintains context data, which it updates as the results 64 are received, to assist in the interpretation of the results 64. In particular, so that the bot 56 can cope with vague element identifiers that arise in natural language, such as ‘its’, ‘this’ or ‘that’, it maintains a context stack 57 which is a history of the most recently interacted with components of the user interface design 70. For example, this allows the bot 56 to resolve the vague identifier ‘its’ to the most recently interacted with component. For example, where the natural language description element “create a text box” is immediately followed by “make its height 20 pixels”, an incident object (entity) in the second phrase is identified using the vague identifier “its”. The bot 56 “remembers” that the last interacted with element is the newly created text box, because that is at the top of the context stack 56, and so resolves the vague identifier “its” to that component.

When a component is ready to be iterated upon the bot 56 informs the users 2. From then on the users 2 can issue commands such as “make the background color of that green”, and the DescribeUI bot will track the contexts to which vague identifiers such as ‘that’ or ‘this’ refer to, and apply the stylistic change to the intended target component.

Alternatively, the users may tell the bot to associate a name to a specific element, allowing the users to refer to an element by its designated name thereafter (e.g. “main navigation”). Unlike ‘this’ or ‘that’ vague qualifiers that resolve to the last interacted with element, a named element can be addressed at any time.

The bot 56 can also process more complex commands, such as telling the bot to nest another component as a child inside the one being edited (which becomes the child's parent). That is, to create a (hierarchical) association between components within the data structure 70.

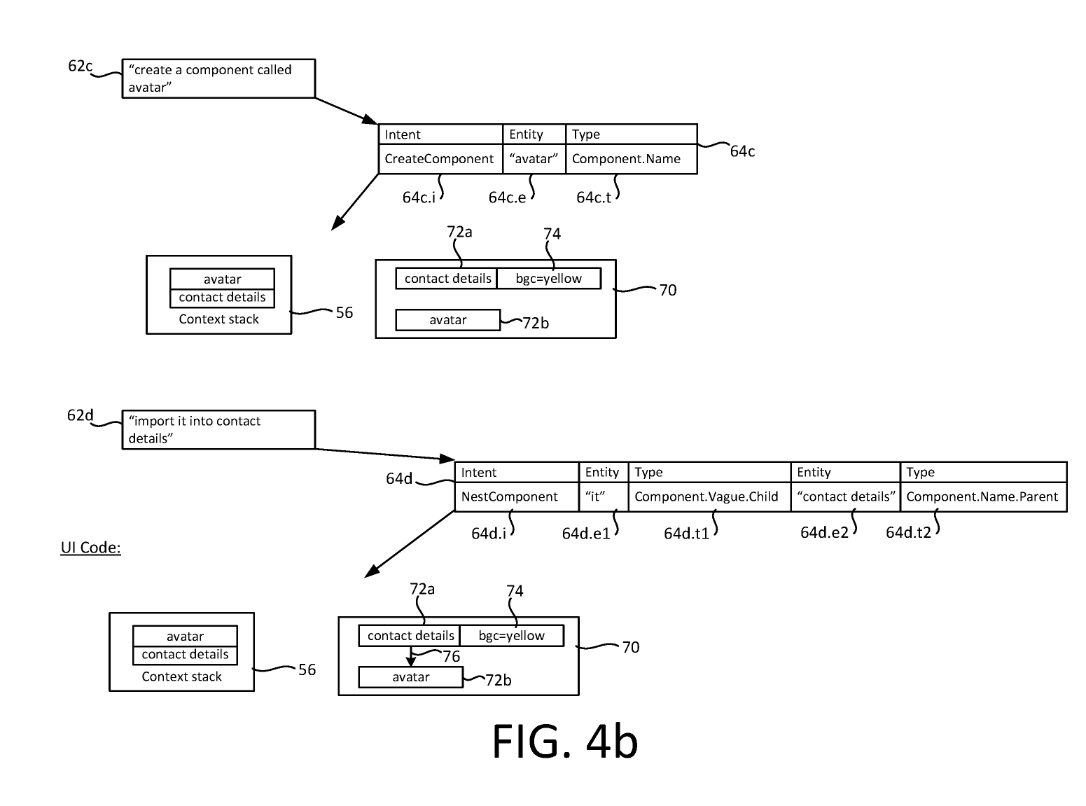

To further aid illustration, an example will now be considered with reference to FIGS. 4a and 4b, which demonstrate how an example sequence of natural language description elements 62 can be process to iteratively amend the UI design 70.

A first NL description element 62a comprises the text “make a component called contact details”. This is processed by the NL interpretation module 32, in order to identify the underlying intent—namely the creation of a new UI component. A first result first result 64a is generated accordingly, which comprises a create component intent identifier 64a.1 (CreateComponent). It also identifies the text string “contact details” as an entity 64a.e, and its type as a component name type 64a.t (Component.Name). This can be readily interpreted by the UI design generation module 54, and in response it is creates a new component 72a having a component name of “contact details” within the data structure 70. It also updates the context stack 56 to identify the contact details component 72a as the most recently interacted with component of the data structure 70.

Subsequently, a second NL description element 62b is received, which comprises the text “make its background color yellow”. The expressed intent is identified by the NL processing as a set background color intent, which is identified by intent identifier 64b.i in result 64b (SetBackgroundColor). Two related entities are also recognized, namely “its” (64b.e1), which corresponding type identifier 64b.t1 identifies as a vague component identifier (Component.Vague), and “yellow” (64b.e2), which corresponding type identifier 64b.e2 identifies as having a color type 64b.t2 (Color). In response to result 64b, UI design generation module 54 uses context stack 56 to resolve the vague identifier “its” to the “contact details” component currently at the top of the stack 56, and modifies the contact details component 72a to add to it background colour display data 74 setting its background colour to yellow. As will be apparent other types of display data, such as layout data can be generated using natural language in a similar fashion, for example defining a size, relative position (e.g. left, center, right, etc.), or orientation of an associated user interface component(s) within the data structure 70, or animation data defining an animation effect (i.e. dynamic visual effect) to be exhibited by an associated UI component(s) of the data structure 70.

Subsequently, a third NL description element is received, which comprises the text “create a component called avatar”. In this case, the intent to create a component is again recognised and identified by intent identifier 64c.i in result 64c. In this case, “avatar” is identified as entity 64c.e, again of the component name type 64c.t (Component.Name). In response, the data structure 70 is modified to create a new component 72b having a name of “avatar”, and the context stack 56 is updated to identify the avatar component as the most recently interacted with component at the top of the stack 56, above contact details.

Subsequently, a fourth natural language description element 62d is received, which comprises the text “import it into context details”. The underlying intent expressed by this element is recognized as the intended nesting of one component within another. That is, the intended creation of a hierarchical association between components, where one is a child and the other is a parent to that child. Generated result 64d accordingly comprises intent identifier 64d.i identifying a nest component intent (NestComponent). In this case, there are two entities: “it” (64d.e1), identified by corresponding type identifier 64d.t1 as being a vague component identifier of the intended child component (Component. Vague. Child); and “contact details” (64d.e2), identified by corresponding type identifier 64d.t2 as being a name of the intended parent component (Component.Name.Parent). The generation module 54 of bot 56 responds by modifying the data structure 70 to create within it a hierarchical relationship 76 between the contact details component 72a and the avatar component 72b (“it” being resolved to the avatar component because it is currently at the top of the context stack 56).

In this manner, the user interface design 70 can be continually updated and modified as desired by users 2, during the communication event.

In addition to setting display data 74, the users 2 can also add functional data to user interface components of the data structure 70. This defines functions of the UI components, for example it may define operations to be performed when one of the component is selected in use, e.g. to navigate through the user interface and access different UI functionality, or other interactive functionality of that component. This allows an interactive user interface to be designed, which can eventually be rendered at an end-user device, for example by incorporating it in an application executed at the user device, or using web-based technology such as HTML or JavaScript.

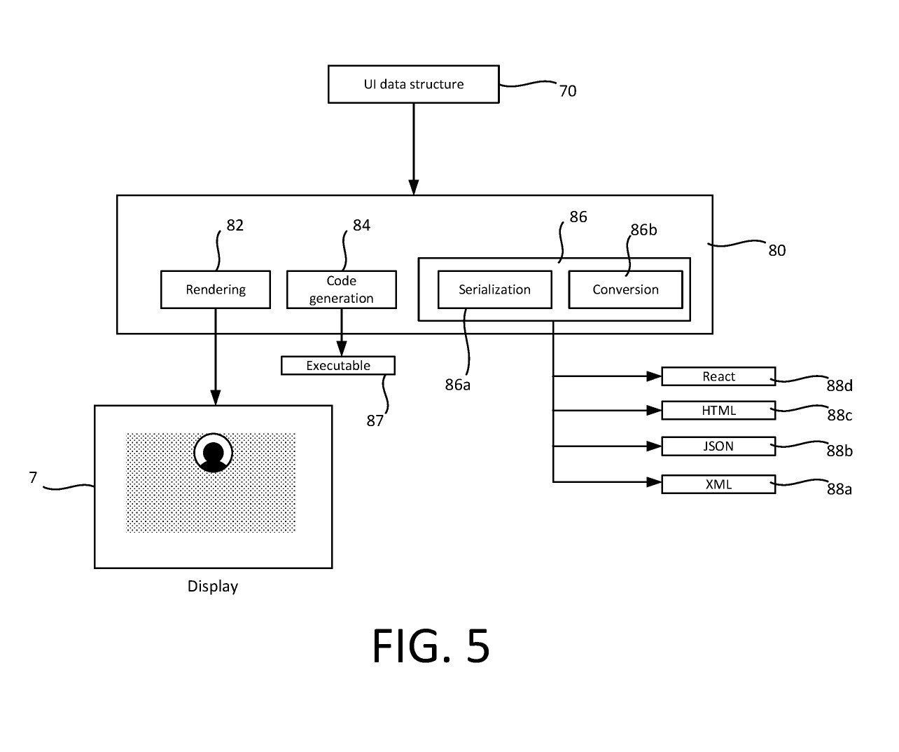

FIG. 5 is a functional block diagram of a processing system 80, which is shown to comprise a rendering module 82, a code generation module 84, and a processing module 86. Again, these represent functionality implemented by respective portions of the back-end software 26 when executed, or alternatively at least part of this functionality may be executed by instructions executed on a processor of a user device or other computer device.

The rendering module 82 uses the generated data structure 70 to control, via the network 8, the display 7 of at least one of the user devices 4 to render a user interface having the attributes captured by the data structure 70. This allows the user 2 of that device to preview and test the user interface, as part of the design process.

When the users are finished editing they can tell the bot 56 to save the design. In this case, the UI data structure 70 can for example be an in-memory data structure i.e. in a processor's local memory (e.g. implemented as a collection of objects and pointers in the local memory), which is serialized by serialization module 86a to generate a serialized version of the data structure 70. That is, a version a format suitable for storage in external memory and exchange between different devices. For example, an XML, HTML, JSON, or React (JavaScript) format, or some other form of user interface code for use by a computer in rendering a user interface exhibiting the intended attributes. Format conversion module 86b is able to convert between these different formats, which allows cross-platform rendering of the user interface based on different UI technologies. Storage and format of the user interface code can differ depending on the implementation. The code can for example be used to render a user interface on a display operated by an end-user, for example it may be interpreted by a web browser executed on an end-user device in order to render the user interface on a display of the end-user device.

Alternatively, the data structure 70 may be generated in an XML 88a, HTML 88c, JSON 88b, or React 88d (JavaScript) format (among others), which is updated directly according to the natural language inputs from users 2.

In a preferred implementation, the UI data structure 70 is both persisted and serialized in XML according to a predefined XML schema. That is, the XML code is iteratively updated each time an intended change is recognized in the natural language inputs. This XML data structure can then be converted to a requested target format on demand (e.g. React, JSON, HTML). The resultant artefacts may be transient i.e. the UI data structure may not be persisted in all of those formats simultaneously, but only transiently in the requested format upon request (leaving it up to the developer to, say, copy or export the resulting HTML, JSON, or React code, etc. as desired).

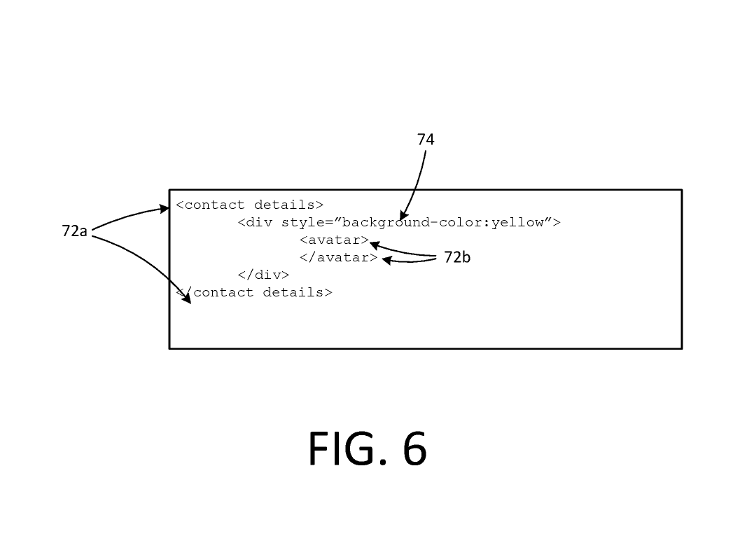

By way of example, FIG. 6 shows an example XML code embodiment of the data structure 70 from the example of FIG. 4. In the XML code, the contact details component 72a and the avatar component 72b are embodied as markup elements “<contact details> . . . </contact details>” and “<avatar></avatar>” respectively. The background colour display data 74 is included within a “<div>” tag of the contact details component 72a. The hierarchical association 76 is embodied by the nesting of “<avatar> . . . </avatar>” within “<contact details> . . . </contact details>”.

As another example, code generation module 84 may use the data structure 70 to generate executable instructions 87 which render, when executed on a processor, a user interface exhibiting the desired attributes captured in the data structure 70. This can, for example, be incorporated in an application that is made available to end users.

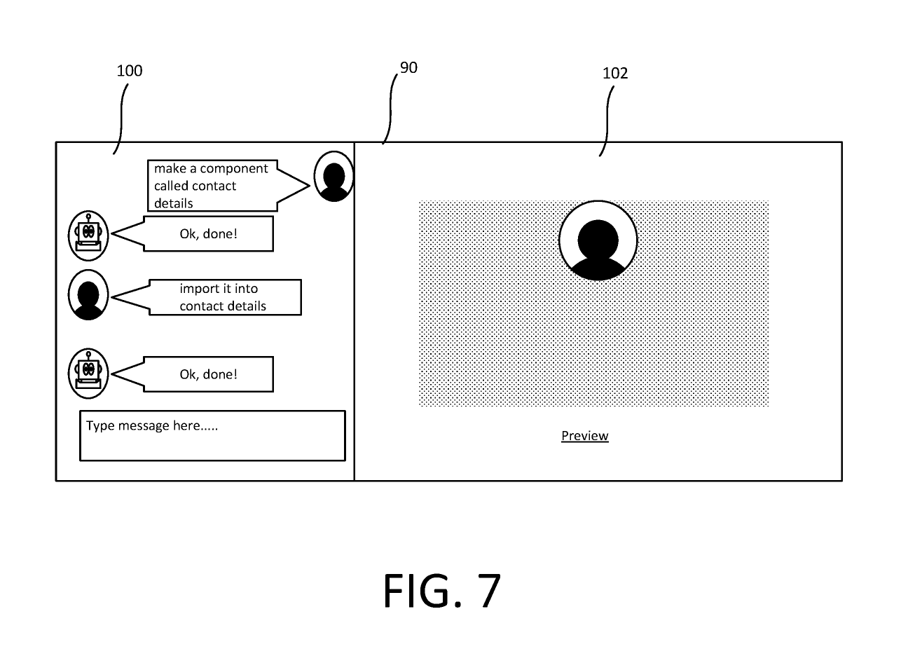

FIG. 7 shows an example of a conversation interface 90 of the client application, which is displayed at the user device 4 as part of the communication event with the bot 56. In this example, a chat window 100 shown on the left, in which users 2 can enter natural language inputs as text messages that are sent as messages to the bot 56. Thought the conversation, the bot responds to inform the users when it has acted upon these. A preview of user interface is displayed on the call as a screen share 102 by the bot (shown on the left hand side), or alternatively a link (e.g. uniform resource locator (URL)) may be provided to a resource that all members of the call can view in real time. The link may provide a functional rendering of the user interface, which is not only displayed to the users 2 but which they can also interact with in an intended manner, for example by selecting displayed components to navigate the user interface.

The rendered user interface on the display 7 can include at least one selectable component, defined by the data structure 70, which is selectable using an input device of the user device 4 to provide a two-way interface between the user 2 and the user device 4. That is, to allow the user to engage with the rendered interface in an interactive manner.

FIG. 8 shows an example architecture of the back-end system 20. In this example, the bot 56 is implemented on a dedicated bot platform 31 and the natural language interpretation module 32 is provided as part of a natural language interpretation service. As will be apparent, there are a variety of suitable bot platforms and NL interpretation services that are currently available, including but not limited to the Microsoft™ bot platform and the language understanding intelligent service (LUIS).

As noted, the natural language interpretation is based on machine learning, whereby the bot developer 12 can train the DescribeUI bot to understand a selection of phrase structures related to user interface design. Once trained, this allows the users 2 to tell the bot whether they wish to amend an existing user interface component or create a new one.

As noted, this functionality can for example be provided by a language interpretation service 30, such as LUIS. Such services provide a generic framework for machine learning-based NL interpretation, which a bot developer 12 can customise to suit his own needs by training a model based on his own selection of phrases.

In this example, the bot developer trains the bot via a developer application program interface (API) 37 of the service 30 by defining a set of intents 92, i.e. intended actions pertaining to the UI being designed, and a set of entities 94 e.g. components or parameters to which those intents can apply. The developer also provides via the developer API 37 example phrases 96 expressing those intents in natural language, to which he applies labels 98 to identify the expressed intents explicitly as well as any entities within the phrases.

This training causes model data 34 to be generated in the electronic storage 24, which can be used by the interpretation module 32, when the bot 56 is operational, to interpret natural language description elements 62 from UI developers 2. These are provided via a functional API 36 of the NL interpretation service 30.

The bot 56 is created and configured via a developer API of the bot platform 31, and accessed via a communication API (e.g. call or chat API) during the communication event. The bot 56 communicates with the natural language interpretation module 32 via the functional API of the interpretation service 30 in this example, e.g. via the network 8.

Note references to software executed on at least one processor (or similar) can mean all of the software are executed on the same processor, or that portions of the code can be executed on different processors, which may or may not be collocated. For example, in the example architecture of FIG. 8, the portion of the back-end code that implements the natural language interpretation is executed as part of the interpretation service 30, and the portion that implements the bot 56 is executed on the bot platform 31. In practice, these portions may be implemented on different processors at different locations, possibly in different data centres which can communicate via the network 8 or a dedicated back-end connection. Note also that “electronic storage” refers generally to one or more electronic storage devices, such as magnetic or solid-state storage devices. For multiple devices, there may or may not be spatially collocated. For example, different parts of the electronic storage 24 may likewise be implemented at different data centres. The program code 26 can be stored in one or more computer readable memory devices. The features of the techniques described below are platform-independent, meaning that the techniques may be implemented on a variety of commercial computing platforms having a variety of processors. For example, the devices may include a computer-readable medium that may be configured to maintain instructions that cause the devices, and more particularly the operating system and associated hardware of the devices to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer system for use in rendering a user interface, the computer system comprising:
an input configured to receive a series of natural language user interface description elements describing intended user interface attributes;
electronic storage configured to hold model data for interpreting the natural language description elements;
an interpretation module configured to apply natural language interpretation to the natural language description elements to interpret them according to the model data, thereby identifying the intended user interface attributes;
a generation module configured to use results of the natural language interpretation to generate a data structure for rendering a user interface exhibiting the identified attributes; and
a rendering module configured to use the data structure to cause a display to render on the display a user interface exhibiting the intended attributes.

2. The computer system according to claim 1, wherein the computer system is configured to generate context data as the series of natural language description elements is received and interpreted, and use the context data to resolve a vague identifier in at least one of the natural language description elements, the vague identifier being resolved to a user interface component of the data structure identified by the context data.

3. The computer system according to claim 2, wherein the context data identifies a most recently interacted with user interface component of the data structure, to which the vague identifier is resolved.

4. The computer system according to claim 1, wherein the natural language interpretation comprises interpreting at least one of the natural language description elements by identifying an intended modification expressed by it in natural language, and the generation module is configured to apply the intended modification to the data structure.

5. The computer system according to claim 4, wherein the computer system is configured to generate context data as the series of natural language description elements is received and interpreted, and use the context data to resolve a vague identifier in at least one of the natural language description elements, the vague identifier being resolved to a user interface component of the data structure identified by the context data; and
wherein the intended modification is expressed by the natural language description element containing the vague identifier and is applied to the user interface component identified by the context data.

6. The computer system according to claim 4, wherein the interpretation module is configured to identify a component name in the description element expressing the intended modification, and the intended modification is applied to a user interface component of the data structure having that name.

7. The computer system according to claim 4, wherein the modification is applied by creating a new user interface component in the data structure.

8. The computer system according to claim 4, wherein the modification is applied by modifying the data structure to associate a user interface component of the data structure with at least one other user interface component of the data structure.

9. The computer system according to claim 8, wherein the data structure is modified to mark the other user interface component as a child to the user interface component.

10. The computer system according to claim 4, wherein the intended modification is applied by generating functional data and/or display data within the data structure in association with at least one user interface component of the data structure, wherein the rendering module is configured to use the functional and/or display data in causing the user interface component to be rendered on the display.

11. The computer system according to claim 10, wherein the display data defines a colour and/or a layout and/or an animation effect for the associated user interface component, which is rendered on the display.

12. The computer system according to claim 10, wherein the functional data defines an action to be performed, wherein the rendering module is configured to use the functional data to render the associated user interface as a selectable component such that the defined action is performed when that component is selected.

13. The computer system according to claim 1, comprising a code generation module configured to use the data structure to generate executable instructions configured, when executed on a processor, to render a user interface exhibiting the intended attributes.

14. The computer system according to claim 1, wherein the natural language description elements are received as part of a real-time conversation between at least one user and a bot comprising the generation module.

15. The computer system according to claim 1, wherein the data structure has a markup language format, a JSON format, or a React format.

16. The computer system according to claim 15, comprising a format conversion module configured to generate a corresponding data structure having a different format.

17. The computer system according to claim 1, wherein the data structure is an in-memory data structure, and the computer system comprises a serialisation module configured to generate a serialized version of the data structure.

18. The computer system according to claim 17, wherein the serialized version of the data structure has a markup language format, a JSON format, or a React format.

19. A computer-implemented method of causing a user interface to be rendered on a display, the method comprising implementing, by a computer system, the following steps:
receiving a series of natural language user interface description elements describing intended user interface attributes;
causing natural language interpretation to be applied to the natural language description elements to interpret them according to electronically stored model data, thereby identifying the intended user interface attributes;
using results of the natural language interpretation to generate a data structure for rendering a user interface exhibiting the identified attributes; and
using the data structure to cause a display to render on the display a user interface exhibiting the intended attributes.

20. A computer program product comprising code stored on a computer readable storage medium and configured when executed to implement a method of causing a user interface to be rendered on a display, the method comprising the following steps:
receiving a series of natural language user interface description elements describing intended user interface attributes;
causing natural language interpretation to be applied to the natural language description elements to interpret them according to electronically stored model data, thereby identifying the intended user interface attributes;
using results of the natural language interpretation to generate a data structure for rendering a user interface exhibiting the identified attributes; and
using the data structure to cause a display to render on the display a user interface exhibiting the intended attributes.
